(19) United States
(12) Patent Application Publication
(10) Pub. No.: US 2013/0115078 A1
(43) Pub. Date: May 9, 2013

(54) FAN ASSEMBLY WITH RETAINING MODULE

(71) Applicants: SHUANG FU, Shenzhen City (CN); XIAO-WEI XUE, Shenzhen City (CN)

(72) Inventors: SHUANG FU, Shenzhen City (CN); XIAO-WEI XUE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/585,189

(22) Filed: Aug. 14, 2012

(30) Foreign Application Priority Data
Nov. 8, 2011 (CN) 201110349594.3

(51) Int. Cl. F16M 13/00; F01D 25/28

(52) U.S. Cl. 415/213.1; 248/674

(57) ABSTRACT

A retaining module secures a fan. The bracket receives the fan. The bracket includes a front wall. The front wall defines a vent. A retaining member includes a body, a number of locking portions, and two retaining portions. The body defines an opening to communicate with the vent of bracket. The locking portions extends through the front wall. The retaining portions are engaged with the front wall to attach the retaining member to the bracket.

### BACKGROUND

The disclosure generally relates to fan retaining modules typically used in computer systems.

### DESCRIPTION OF RELATED ART

Heat dissipation devices, such as fans, are provided in computers to remove heat from heat generating components. Typically, one or more of these fans are directly screwed onto a rack adjacent to the heat generating components in the computer. However, the process of assembly is time-consuming. There is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a fan assembly of one embodiment.

FIG. 2 is an enlarged, isometric view of a retaining member of FIG. 1, showing another aspect thereof.

FIG. 3 is an assembled view of the fan assembly of FIG. 1.

FIG. 4 is a cutaway view of a bracket and the retaining member of FIG. 1 when assembled.

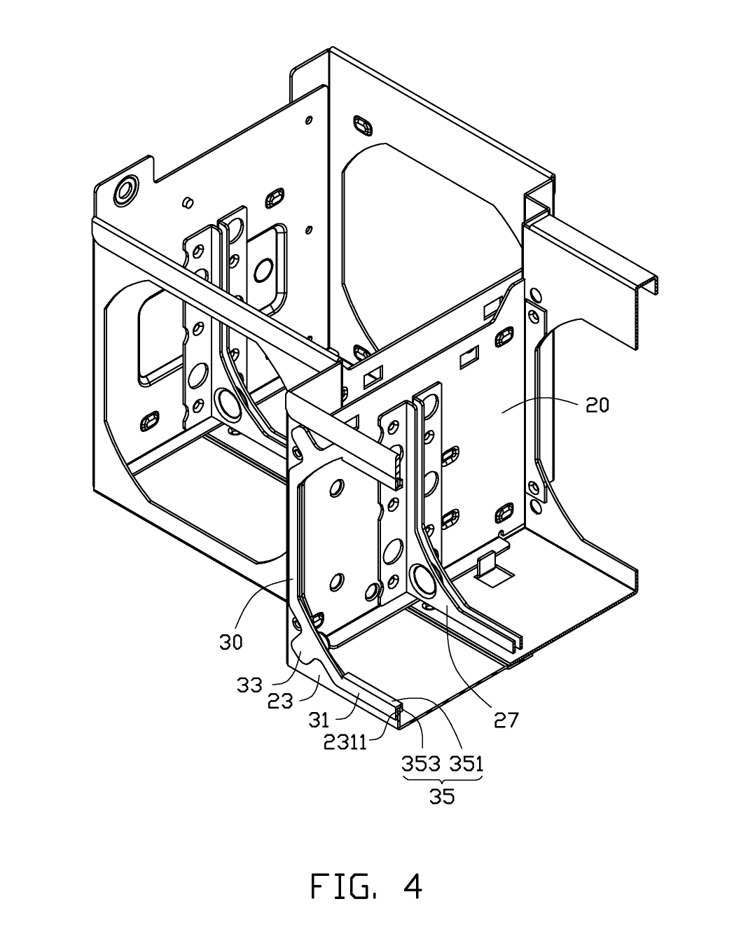

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

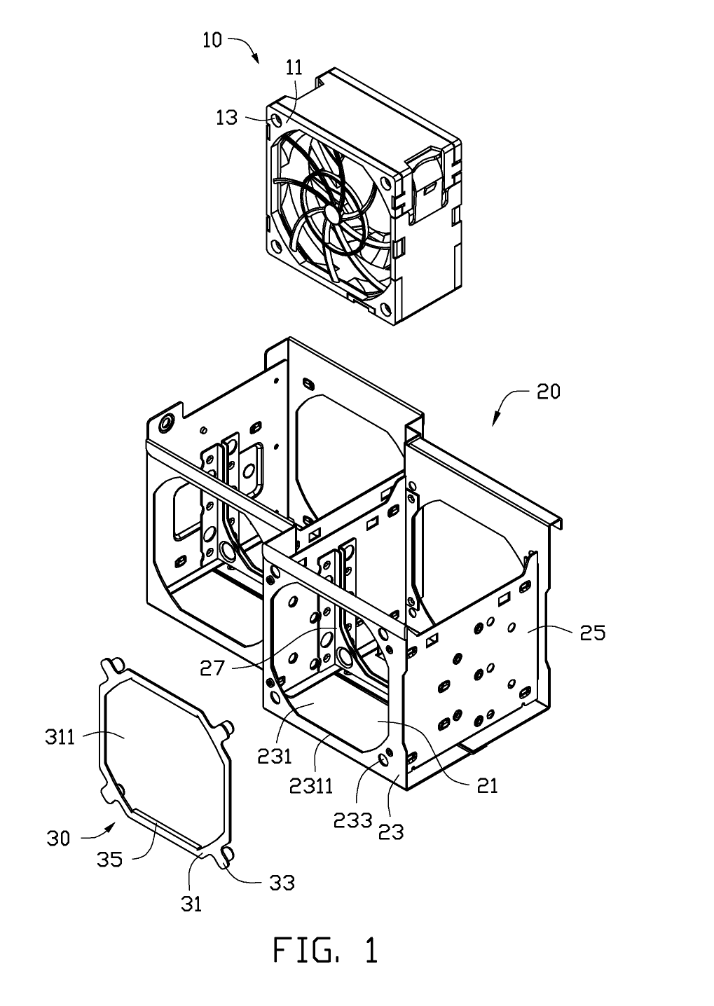

FIG. 1 shows one embodiment of a fan assembly. The fan assembly includes a retaining module for receiving a plurality of fans 10 (only one shown in the embodiment). The retaining module includes a bracket 20 and a retaining member 30.

The fan 10 defines a plurality of locking holes 13 in a front side thereof. In the illustrated embodiment, there are four locking holes 13 in four corners of the front side of the fan 10.

The bracket 20 includes two receiving cells 21. Each of the receiving cells 21 can receive two fans 10 therein. The receiving cells 21 are arranged in a staggered manner, that is, the receiving cells 21 are not aligned along a straight line. Each receiving cell 21 includes a front wall 23, a sidewall 25, and an interval wall 27. The interval wall 27 is substantially parallel to the sidewall 25. The front wall 23 defines a vent 231 for allowing airflow from the fan 10 to blow therethrough. The front wall 23 is substantially square. The front wall 23 defines four securing holes 233 at four corners thereof. The front wall 23 includes two securing flanges 2311 at opposite top and bottom edges of the vent 231, respectively, for securing the retaining member 30.

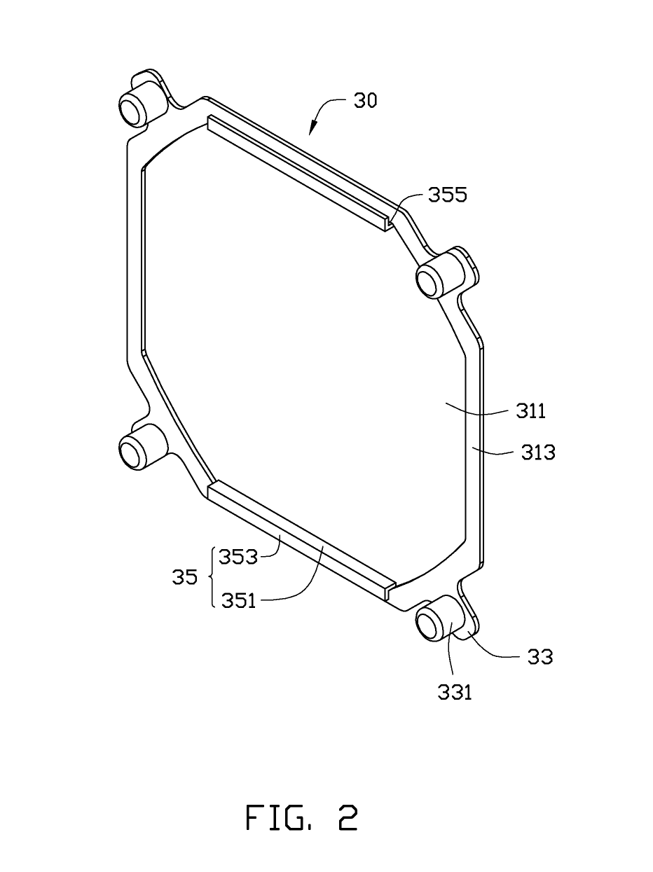

Referring to FIG. 2, the retaining member 30 is substantially square. The retaining member 30 includes a body 313, four locking portions 33 located at four corners of the body 313, and two retaining portions 35 located on opposite top and bottom sides the body 313. An opening 311 is defined in the body 313. The retaining portions 35 are adjacent to the opening 35. A retaining slot 355 is defined in each retaining portion 35. Each of the retaining portions 35 is elongated, and has an L-shaped transverse cross-section. Each retaining portion 35 includes a connecting flange 351 and a free retaining flange 353. The free retaining flange 353 is substantially parallel to the body 313. Each of the locking portions 33 includes a post 331.

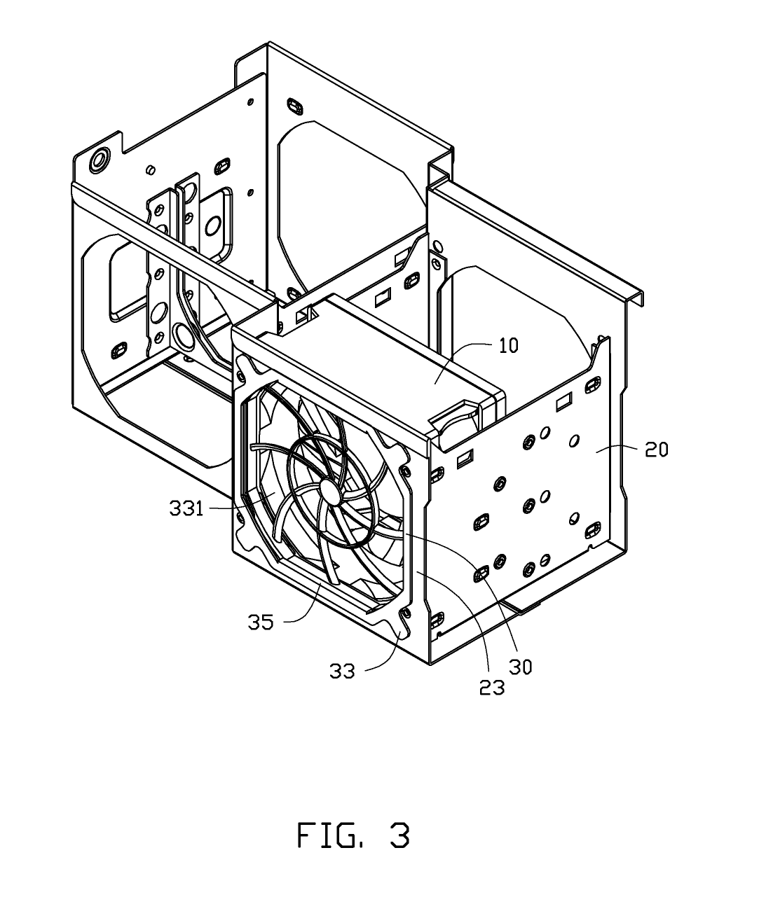

Referring to FIG. 2 and FIG. 3, assembly of the fan assembly will be described in relation to the single fan 10 illustrated. The fan 10 is inserted into the front of a right one of the receiving cells 21, with the locking holes 13 of the fan 10 aligned with the securing holes 233 of the front wall 23. The body 313 of the retaining member 30 is resiliently deformed, to engage the retaining portions 35 of the retaining member 30 with the securing flanges 2311 of the front wall 23. The four posts 331 thus extend through the securing holes 233 and the locking holes 13. In one embodiment, the four posts 331 are interferingly engaged in the locking holes 13. Thereby, the fan 10 is fixed in the bracket 20 by the retaining member 30.

When detaching the fan 10 from the bracket 20, a middle portion of the body 313 of the retaining member 30 is pulled away from the front wall 23 of the bracket 20. A top portion and a bottom portion of the body 313 are thus pulled in oblique directions away from the front wall 23 of the bracket 20, and so the retaining portions 35 of the retaining member 30 are disengaged from the securing flanges 2311 of the front wall 23. Simultaneously, the four posts 331 are disengaged from the locking holes 13, and may further be disengaged from the securing holes 233. The fan 10 can then be drawn vertically out from the bracket 20.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A retaining module for securing a fan, comprising:
a bracket for receiving the fan, the bracket comprising a front wall, and the front wall defining a vent; and
a retaining member comprising a body, a plurality of locking portions, and two retaining portions, the body defining an opening to communicate with the vent of the bracket when the retaining member is attached to the bracket, the body being configured to resiliently deform to engage the retaining portions to the front wall, the retaining portions being adapted to be engaged with the front wall to attach the retaining member to the bracket, and the locking portions being adapted to extend through the front wall and engage with the fan.

2. The retaining module of claim 1, wherein the retaining portions are located on opposite sides of the body adjacent to the opening.

3. The retaining module of claim 2, wherein each of the retaining portions is elongated, and extending directions of the retaining portions are substantially parallel.

4. The retaining module of claim 1, wherein each of the retaining portions has an L-shaped cross section.

5. The retaining module of claim 4, wherein each of the retaining portions comprises a free retaining flange, and the free retaining flange is substantially parallel to the body.

6. The retaining module of claim 1, wherein the body is substantially square, and the plurality of locking portions is located on corners of the body.

7. The retaining module of claim 6, wherein the plurality of locking portions comprises four locking portions, and each of the locking portions comprises a post protruding rearward.

8. The retaining module of claim 1, wherein the bracket further comprises two receiving cells, each of the receiving cells is adapted to receive two fans, and one of the receiving cells comprises the front wall.

9. The retaining module of claim 1, wherein the receiving cells are staggered.

10. A fan assembly, comprising:
a fan defining a plurality of locking holes;
a bracket having the fan received therein, the bracket comprising a front wall, and the front wall defining a vent; and
a retaining member comprising a body, a plurality of locking portions, and two retaining portions, the body defining an opening communicating with the vent of the bracket, the retaining portions being engaged with the front wall thereby attaching the retaining member to the bracket, and the locking portions extending through the front wall and being engaged in the locking holes;
wherein the body is resiliently deformable and thereby the retaining portions are disengageable from the front wall.

11. The fan assembly of claim 10, wherein the retaining portions are located on opposite sides of the body adjacent to the opening.

12. The fan assembly of claim 11, wherein each of the retaining portions has a lengthwise configuration, and extending directions of the retaining portions are substantially parallel.

13. The fan assembly of claim 10, wherein each of the retaining portions has an L-shaped cross section.

14. The fan assembly of claim 13, wherein each of the retaining portions comprises a free retaining flange, and the free retaining flange is substantially parallel to the body.

15. The fan assembly of claim 10, wherein the body is substantially square, and the plurality of locking portions is located on corners of the body.

16. The fan assembly of claim 15, wherein the plurality of locking portions comprising at four locking portions, and each of the four locking portions comprises a post protruding toward the bracket.

17. The fan assembly of claim 10, wherein the bracket further comprises two receiving cells, each of the receiving cells is adapted to receive two fans, and one of the receiving cells comprises the front wall.

18. The fan assembly of claim 10, wherein the receiving cells are staggered.

19. A fan assembly, comprising:
a fan defining a plurality of locking holes;
a bracket having the fan received therein, the bracket comprising a front wall; and
a retaining member comprising a body, a plurality of locking portions, and two retaining portions, the retaining portions being engaged with the front wall, the retaining portions extending from an outer side of the front wall to an inner side of the front wall to hook the front wall, and the locking portions extending through the front wall and being engaged in the locking holes;
wherein the body is resiliently deformable and thereby the retaining portions are disengageable from the front wall.

20. The fan assembly of claim 19, wherein the retaining portions are located on opposite sides of the body adjacent to the opening, each of the retaining portions has a lengthwise configuration, and extending directions of the retaining portions are substantially parallel.
